(19) United States
(12) Patent Application Publication
(10) Pub. No.: US 2020/0257994 A1
(43) Pub. Date: Aug. 13, 2020

(54) INFERENCE PROCESSING SYSTEM, INFERENCE PROCESSING DEVICE, AND COMPUTER PROGRAM PRODUCT

(71) Applicant: FUJITSU CLIENT COMPUTING LIMITED, Kanagawa (JP)

(72) Inventors: Yuichiro Ikeda, Kawasaki (JP); Masatoshi Kimura, Kawasaki (JP); Tomohiro Ishida, Kawasaki (JP); Kai Mihara, Kawasaki (JP)

(73) Assignee: FUJITSU CLIENT COMPUTING LIMITED, Kanagawa (JP)

(21) Appl. No.: 16/750,485

(22) Filed: Jan. 23, 2020

(30) Foreign Application Priority Data
Feb. 13, 2019 (JP) 2019-023895

(51) Int. Cl. G06N 5/04

(52) U.S. Cl. CPC G06N 5/04

(57) ABSTRACT

An inference processing system includes inference processing devices and performs inference processing such that a succeeding inference processing device performs inference processing to a result of inference processing by a preceding inference processing device. The inference processing system includes: inference-result storage that stores therein results of the inference processing of the inference processing devices; a processing delay detector that detects occurrence of delay in the inference processing; a selector that selects an inference processing device executable of the inference processing of the inference processing device having the delay; and an input-output controller that inputs, to the selected inference processing device, the result of the inference of the inference processing device preceding the inference processing device having the delay and causes the selected inference processing device to output the result of the inference processing to the inference processing device succeeding the inference processing device having the delay.

### CROSS-REFERENCE TO RELATED APPLICATIONS

This application is based upon and claims the benefit of priority from Japanese Patent Application No. 2019-023895, filed Feb. 13, 2019, the entire contents of which are incorporated herein by reference.

### FIELD

Embodiments described herein relate generally to an inference processing system, an inference processing device, and a computer program product.

### BACKGROUND

Conventionally, parallel computing using a plurality of calculators or computing units is known. For example, information processing systems that transmit and receive data among the calculators through Ethernet (registered trademark) are available.

In recent years, personal computers (PCs) have been improved in performance to be able to acquire a massive amount of seamless data (e.g., images) from outside for use in parallel processing such as inference processing.

In parallel processing, however, each processing system may have a larger load depending on actual objects to process.

In inferring the age and the gender of persons included in an image generated by a camera, for example, the processing system has a larger load for processing an image of a crowded area than for processing an image of a non-crowded area.

In the case that two or more processors operate such that a processor in a subsequent stage performs processing using results of processing by a preceding processor or two or more processing systems may perform parallel processing, any of the processors or the processing systems may have larger processing load, resulting in delay in the processing. In such a case, the succeeding processor using the results of the preceding processor and another processing system may be continuously placed in a standby state, for example, leading to reducing the efficiency of the entire system.

It is thus preferable to provide an inference processing system, an inference processing device, and a computer program product that can appropriately distribute processing load and efficiently perform inference processing.

### SUMMARY

According to one aspect, an inference processing system includes inference processing devices and performs inference processing such that a succeeding inference processing device performs inference processing to a result of inference processing performed by a preceding inference processing device. The inference processing system includes inference-result storage that stores therein results of the inference processing of the inference processing devices; a processing delay detector configured to detect occurrence of delay in the inference processing of the inference processing devices; a selector configured to select one of the inference processing devices, the one being executable of inference processing same as the inference processing of the inference processing device having the delay; and an input-output controller configured to input, to the inference processing device selected by the selector, the result of the inference processing of the inference processing device preceding the inference processing device having the delay, and to cause the selected inference processing device to output the result of the inference processing to the inference processing device succeeding the inference processing device having the delay.

### BRIEF DESCRIPTION OF THE DRAWINGS

FIG. 1 is a diagram of an exemplary hardware configuration of an information processing system according to an embodiment;

FIG. 2 is a diagram of an exemplary functional configuration of an information processing device and inference processing devices;

FIG. 3 is a diagram of an example of a data format of an intermediate result;

FIG. 4 is a processing flowchart according to the embodiment;

FIG. 5 illustrates operations with no processing delay according to a first embodiment;

FIG. 6 illustrates operations with processing delay according to the first embodiment;

FIG. 7 illustrates an exemplary configuration of the devices and operations with no processing delay according to a second embodiment;

FIG. 8 illustrates operations with processing delay according to the second embodiment;

FIG. 9 illustrates an exemplary configuration of the devices and operations with no processing delay according to a third embodiment; and

FIG. 10 illustrates an exemplary configuration of the devices and operations with processing delay according to a fourth embodiment.

### DETAILED DESCRIPTION

Exemplary embodiments of an inference processing device and an inference processing system will be described below in detail with reference to the accompanying drawings. The embodiments are not intended to limit the scope of this disclosure. Throughout this disclosure, elements or components having same or like functions are denoted by same or like reference numerals, therefore, overlapping explanation thereof is omitted.

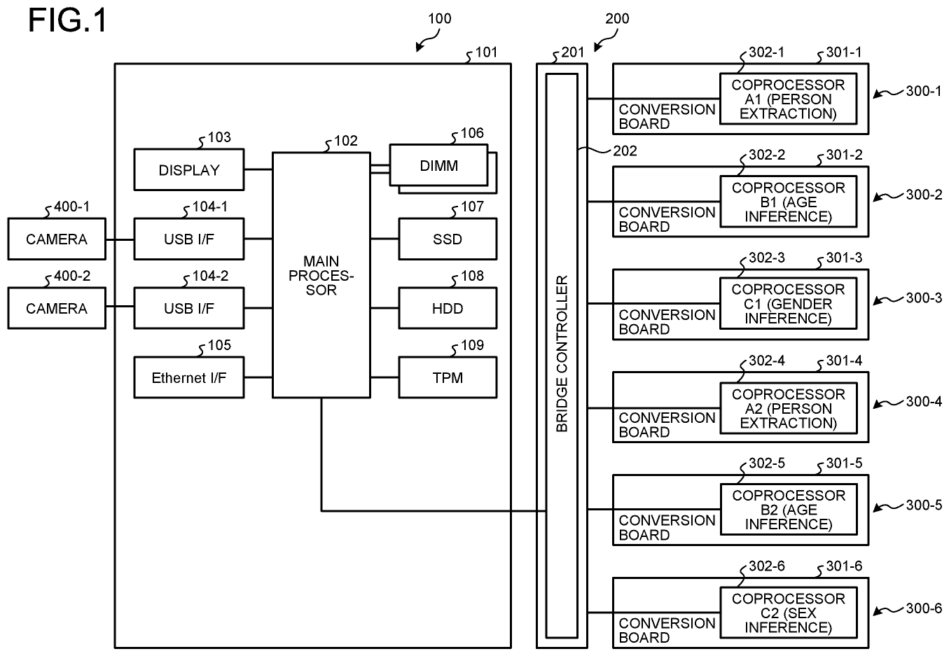

FIG. 1 is a diagram of an exemplary hardware configuration of an information processing system according to an embodiment. As illustrated in FIG. 1, an information processing system 1 includes an information processing device 100, a relay device 200, six inference processing devices 300-1 to 300-6, and two cameras 400-1 and 400-2.

The information processing device 100 includes a motherboard 101, a main processor 102, a display 103, universal serial bus (USB) interfaces (I/F) 104-1 and 104-2, an Ethernet (registered trademark) interface (I/F) 105, a dual inline memory module (DIMM) 106, a solid state drive (SSD) 107, a hard disk drive (HDD) 108, and a trusted platform module (TPM) 109.

The motherboard 101 is a circuit board on which parts and elements are mounted to implement the main functions of the information processing device 100. The main processor 102 implements the main functions of the information processing device 100. The main processor 102 can be an electronic circuit, such as a central processing unit (CPU) and a micro-processing unit (MPU). The display 103 functions as a display unit that displays various kinds of information.

The USB interfaces 104-1 and 104-are each connectable to a USB device to allow communications between the USB device and the main processor 102 therethrough. In the information processing system 1 according to the present embodiment, the camera 400-1 being the USB device is connected to the USB interface 104-1 while the camera 400-2 is connected to the USB interface 104-2.

Image data (hereinafter, referred to as camera images) generated by the cameras 400-1 and 400-2 are input to the information processing device 100 via the USB interfaces 104-1 and 104-2, respectively.

The Ethernet interface 105 is connectable to an Ethernet cable to allow communications between an external device and the main processor 102 via the Ethernet cable.

The DIMM 106 is a volatile storage medium such as a random access memory (RAM) that can temporarily store therein various kinds of information.

The SSD 107 and the HDD 108 are non-volatile storage media that can store therein various kinds of information after power-off. The SSD 107 and the HDD 108 store therein various computer programs executed by the main processor 102, model files 304, various kinds of setting information on the operations of the information processing device 100, and results of inference (intermediate results) of the inference processing devices 300-1 to 300-6, for example.

The TPM 109 is a module that implements a security function of the system.

The relay device 200 includes a bridge board 201 and a bridge controller 202. The bridge board 201 is a circuit board on which the bridge controller 202 and a plurality of slots (not illustrated) are mounted. The slots mount thereon the inference processing devices 300-1 to 300-6 serving as a board computer. The I/O interface used for the bridge board 201 is exemplified by a peripheral component interconnect express (PCIe).

The bridge controller 202 serve to bridge-connect the inference processing devices 300 to the information processing device 100 via the slots to mediate or relay the communications between the information processing device 100 and the inference processing devices 300.

The inference processing devices 300-1 to 300-6 are connected to the relay device 200 in parallel to one another. The inference processing devices 300-1 to 300-6 include conversion boards 301-1 to 301-6 and coprocessors 302-1 to 302-6, respectively.

The conversion boards 301-1 to 301-6 are also referred to as accelerator boards on which additional hardware is mounted to increase the processability of the information processing system 1.

The coprocessors 302-1 to 302-6 are suitable for computation, such as artificial intelligence (AI) inference and image processing. The coprocessors 302-1 to 302-6 can be accelerators, such as graphics processing units (GPUs) and dedicated chips. The coprocessors 302-1 to 302-6 may be a combination of the CPU and the GPU.

AI inference is inference processing utilizing AI and includes inference processing based on an inference model through a multilayered neural network (hierarchical neural network).

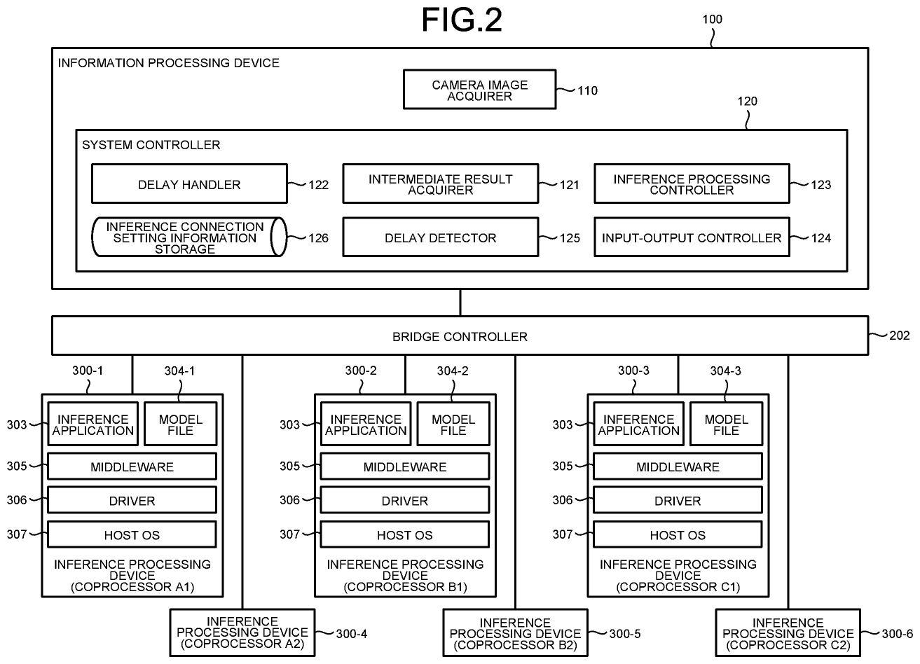

The inference processing devices 300-1 to 300-6 according to the present embodiment are divided into two groups, that is, a first group of the inference processing devices 300-1 to 300-3 and a second group of the inference processing devices 300-4 to 300-6. The first group and the second group have the same configuration and can perform the same processing. In other words, in terms of processing functions, the inference processing device 300-1 and the inference processing device 300-4 can be mutually substituted for, the inference processing device 300-2 and the inference processing device 300-5 can be mutually substituted for, and the inference processing device 300-3 and the inference processing device 300-6 can be mutually substituted for. For this reason, FIG. 2 illustrates the detailed configuration of the first group of the inference processing devices 300-1 to 300-3 alone, and the following will mainly describe the configuration of the inference processing devices 300-1 to 300-3.

FIG. 2 is a diagram of an exemplary functional configuration of the information processing device and the inference processing devices.

The information processing device 100 includes a camera image acquirer 110 and a system controller 120. The system controller 120 includes an intermediate result acquirer 121, a delay handler 122, an inference processing controller 123, an input-output controller 124, a delay detector 125, and an inference connection setting information storage 126.

The main processor 102, for example, may include the functional elements of the information processing device 100.

The camera image acquirer 110 receives camera images from the cameras 400-1 and 400-2 and temporarily stores the acquired camera images in the storage medium, such as the DIMM 106 and the SSD 107.

The intermediate result acquirer 121 of the system controller 120 acquires intermediate results of the processing from each stage of the inference processing devices and temporarily stores them in the storage device, such as the SSD 107. Specifically, the intermediate result acquirer 121 acquires a first inference result from the inference processing device 300-1 (person extraction inference) and a second inference result from the inference processing device 300-2 (age inference) and temporarily stores them in the storage as the intermediate results.

The intermediate results include inference results derived through each stage of the inference processing. Examples of the first inference result include a person identifier for identifying a person inferred or extracted through the person extraction inference by the inference processing device 300-1, positional information on the person in the camera image, and reliability of inference or extraction.

The second inference result includes the age of the person inferred through the age inference by the inference processing device 300-2 and the reliability of inference, for example. The first inference result and the second inference result are output in association with an image identifier for identifying a common camera image serving as an object to process. The second inference result is output in association with the corresponding person identifier in the first inference result. The second inference result may be added to the first inference result for output.

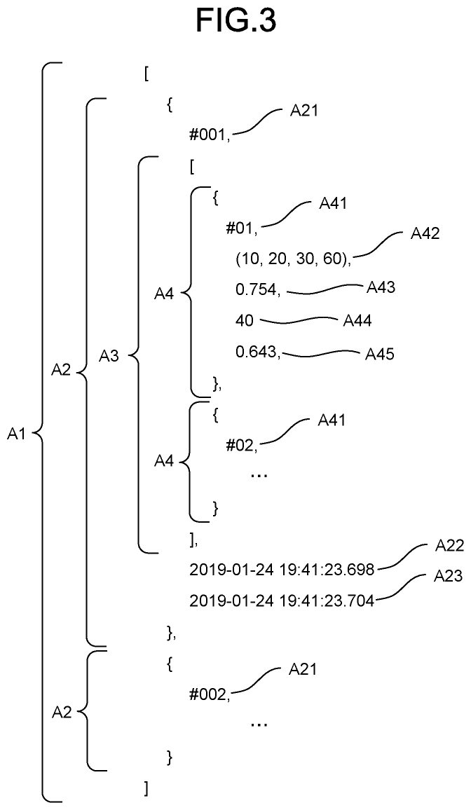

FIG. 3 is a diagram of an example of a data format of an intermediate result. FIG. 3 illustrates an example of the second inference result added to the first inference result for output and recording.

In FIG. 3, the intermediate result is recorded in a region Al defined by the square brackets “[]” at the beginning and the end representing a data section. The region A1, i.e., the data section inside the square brackets includes detailed data sections representing object image data, i.e., one or more regions A2 defined by the curly brackets “{}” representing data of each person included in the object image data in the present embodiment. The intermediate result of each camera image is recorded in the region A2.

The region A2 includes an image identifier A21 (#001) for identifying a camera image. The region A2 also includes a region A3 defined by the square brackets “[]”. The region A2 includes inference-completion date and time A22 of the inference processing device 300 and reception date and time A23 of the intermediate result by the intermediate result acquirer 121. In this example, the completion date and time A22 are set to the completion date and time of the age inference by the inference processing device 300-2.

The region A3 includes one or more regions A4 defined by the curly brackets “{}”. The region A4 is generated for each person extracted or inferred from the camera image identified by the image identifier A21, and the intermediate result (inference result) of each person is recorded in the region A4.

Specifically, the region A4 includes a person identifier A41 (e.g., #01 and #02) for identifying each extracted person. The region A4 also includes positional information A42 on the person identified by the person identifier A41 inferred as the first inference result and reliability A43 of the inference. The region A4 also includes age A44 of the person identified by the person identifier A41 inferred as the second inference result and reliability A45 of the inference.

As described above, the intermediate result illustrated in FIG. 3 includes the items of camera images and persons in a nesting manner such that the result of the second inference processing is added to the result of the first inference processing.

If the intermediate result is the first inference result, the items in the region A4 are the person identifier A41, the positional information A42, and the reliability A43, and the age A44, and the reliability A45 are null. The processing date and time A22 are the completion date and time of the person extraction inference by the inference processing device 300-1.

The inference processing device 300-3 may output an inference result (third inference result) of the inference processing in the same format as the second inference result. In this case, the third inference result is recorded in the region A4 of the corresponding person (person identifier) in the same manner as the second inference result.

Referring back to FIG. 2, in response to occurrence of delay in the processing of any of the inference processing devices 300-1 to 300-6, the delay handler 122 of the system controller 120 performs delay handling processing, which will be described later in detail, to reduce the effects of the delay to a minimum.

The inference processing controller 123 controls the inference processing of the inference processing devices 300-1 to 300-6.

Under the control of the inference processing controller 123, the input-output controller 124 specifies and sets the source of inference data and the destination of inference result data for the inference processing devices 300-1 to 300-6, which will be described later in detail.

The delay detector 125 detects an inference processing device with processing delay while monitoring the inference processing devices 300-1 to 300-6, and notifies the delay handler 122 of the detected inference processing device. In this case, the delay detecting method can be optional and variously set.

The delay detector 125, for example, may detect the inference processing device having processing delay from the inference processing devices 300-1 to 300-6 by receiving a notification that a given allowable processing time has elapsed from each of the inference processing devices 300-1 to 300-6.

For another example, the delay detector 125 may detect the inference processing device having processing delay from the inference processing devices 300-1 to 300-6 by detecting a failure of the intermediate result acquirer 121 in acquiring an intermediate result within a given allowable result-acquiring time or a failure of two or more inference processing devices in acquiring an inference result in cooperation within a given allowable result-acquiring time.

The delay detector 125 may detect the inference processing device having processing delay from the inference processing devices 300-1 to 300-6 by receiving a notification that the preceding inference processing device has failed in receiving an intermediate result (inference result of the preceding inference processing device) within a given time.

The inference connection setting information storage 126 stores therein information on input-output setting of the inference processing devices 300-1 to 300-6 in a normal operation state with no processing delay. The input-output setting information includes information for identifying the inference processing device as the source of the inference processing data and information for identifying the inference processing device as the destination of the inference result data.

The inference connection setting information storage 126 stores therein in advance input-output setting information of the inference processing devices 300-1 to 300-6 (and input-output setting information of another inference processing device such as a spare inference processing device, as necessary), in order for the other inference processing devices to reduce the effects of the delay if any of the inference processing devices delays in processing.

The inference connection setting information storage 126 further stores therein in advance information on one or more items of inference processing to be newly or additionally allocated to any of the inference processing devices 300-1 to 300-6 (and another inference processing device such as a spare inference processing device, as necessary).

The following describes the configuration of the inference processing devices 300-1 to 300-6.

The inference processing devices 300-1 to 300-6 basically include the same configuration. The inference processing devices 300-1 to 300-6 hold the model files 304-1 to 304-6, respectively, in a storage medium (not illustrated) as learned inference models, which are generated by machine learning of inference models through a hierarchical neural network.

To facilitate understanding, FIG. 2 depicts that the inference processing devices 300-1 to 300-6 each include one model file corresponding to one inference operation. Alternatively, one inference processing device may store therein a plurality of model files to be able to switch model files or switch operational procedures using one model file, thereby selectively performing any of inference operations.

With a margin of processing capacity, the inference processing device may perform two or more inference operations in series or in parallel by one or more model files for the two or more inference operations.

The coprocessors 302-1 to 302-6 read the corresponding model files 304-1 to 304-6 to perform the inference processing based on the read model file (e.g., the model file 304-1 for the coprocessor 302-1).

Unless otherwise specified, the inference processing devices 300-1 to 300-3 according to the present embodiment basically hold the model files 304-1 to 304-3 for different inference operations, respectively. The inference processing devices 300-4 to 300-6 hold the model files for different inference operations.

Unless otherwise specified, the model file 304-1 held by the inference processing device 300-1 is the same as the model file held by the inference processing device 300-4. The model file 304-2 held by the inference processing device 300-2 is the same as the model file held by the inference processing device 300-5. The model file 304-3 held by the inference processing device 300-3 is the same as the model file held by the inference processing device 300-6.

The following describes an exemplary construction of a system that detects a person from a camera image and infers or determines the age and gender of the person. In this case, the model files 304-1 to 304-3 correspond to the succeeding inference processing.

Specifically, the model file 304-1 corresponds to the person extraction inference for extracting an image region (person image) of the person from the camera image.

Consequently, as illustrated in FIG. 1, the inference processing devices 300-1 and 300-4 according to the present embodiment perform the person extraction inference.

The model file 304-2 corresponds to the age inference for inferring the age of the person from the appearance features of the person image.

Thus, as illustrated in FIG. 1, the inference processing devices 300-2 and 300-5 according to the present embodiment infers the age of the person.

The model file 304-3 corresponds to the gender inference for inferring the gender from the appearance features of the person image.

Thus, as illustrated in FIG. 1, the inference processing devices 300-3 and 300-6 according to the present embodiment infers the gender of the person.

To execute an inference application 303, the coprocessors 302-1 to 302-3 of the inference processing devices 300-1 to 300-3 load the model files 304-1 to 304-3 from the inference processing devices 300-1 to 300-3, respectively. In a normal state, the coprocessors 302-1 to 302-3 as a whole perform a series of inference processing for inferring the age and gender of the person photographed by the camera 400-1.

Similarly, to execute the inference application 303, the coprocessors 302-4 to 302-6 of the inference processing devices 300-4 to 300-6 load the model files from the inference processing devices 300-4 to 300-6. In a normal state, the coprocessors 302-4 to 302-6 as a whole perform a series of inference processing for inferring the age and gender of the person photographed by the camera 400-2.

In this case, the inference processing devices 300-4 to 300-6 may hold the model files 304-1 to 304-3 and the model files in advance, respectively. Alternatively, the model files 304-1 to 304-3 and the model files used by the inference processing devices 300-4 to 300-6 may be transmitted or transferred to the inference processing devices 300-1 to 300-6, respectively, from the information processing device 100 upon start-up of the information processing system 1, for example.

The following describes the operations according to a first embodiment.

The system controller 120 controls the operations of the inference processing devices 300-1 to 300-6.

After start-up of the information processing system 1, for example, the system controller 120 reads the model files 304-1 to 304-3 for the inference processing devices 300-1 to 300-3, the model files for the inference processing devices 300-4 to 300-6, middleware 305-1 to 305-3 for the inference processing devices 300-1 to 300-3, and middleware for the inference processing devices 300-4 to 300-6 from the SSD 107 and/or the HDD 108. The system controller 120 loads the files and the middleware into the corresponding inference processing devices 300-1 to 300-6 via the bridge controller 202.

Specifically, as to the inference processing device 300-1, for example, the system controller 120 loads the model file 304-1 and the middleware 305-1 into the inference processing device 300-1.

As a result, the inference processing devices 300-1 to 300-6 can use the corresponding model files to perform given inference processing.

The system controller 120 causes the inference processing device 300 to perform the inference processing by inputting thereto a camera image temporarily stored by the camera image acquirer 110 and the camera identifier of the camera image.

As illustrated in FIG. 2, the inference processing devices 300-1 to 300-3 include the inference application 303, the model files 304-1 to 304-3, the middleware 305, a driver 306 and a host operating system (OS) 307.

The inference processing devices 300-4 to 300-6 have the same configuration as the inference processing devices 300-1 to 300-3.

The inference processing devices 300-1 to 300-6 have the same configuration, so that the following mainly describes the inference processing device 300-1 as a representative.

The inference application 303 of the inference processing device 300-1 configured above loads the middleware 305 and the model file 304-1 by, for example, a virtual environment technique in response to the load instruction from the system controller 120.

The inference application 303 serves to initialize the middleware 305 and the model file 304-1 at the time of start-up of the inference processing device 300-1.

By loading the model files 304-1 to 304-3, the inference processing devices 300-1 to 300-3 perform the inference processing sequentially, so that the succeeding inference processing device utilizes the result of the preceding inference processing.

The following describes the inference processing of the present embodiment for detecting a person from a camera image generated by the camera 400 and determining the age and gender of the person, as an example.

The coprocessor 302-1 of the inference processing device 300-1 executes the inference application 303 to perform given inference processing by the loaded middleware 305 and the loaded model file 304-1, that is, the person extraction inference in the present embodiment.

Likewise, the inference processing device 300-2 can perform the age inference, and the inference processing device 300-3 can perform the gender inference. The inference processing device 300-4 can perform the person extraction inference in the same manner as the inference processing device 300-1. The inference processing device 300-5 can perform the age inference in the same manner as the inference processing device 300-2. The inference processing device 300-6 can perform the gender inference in the same manner as the inference processing device 300-3.

### First Embodiment

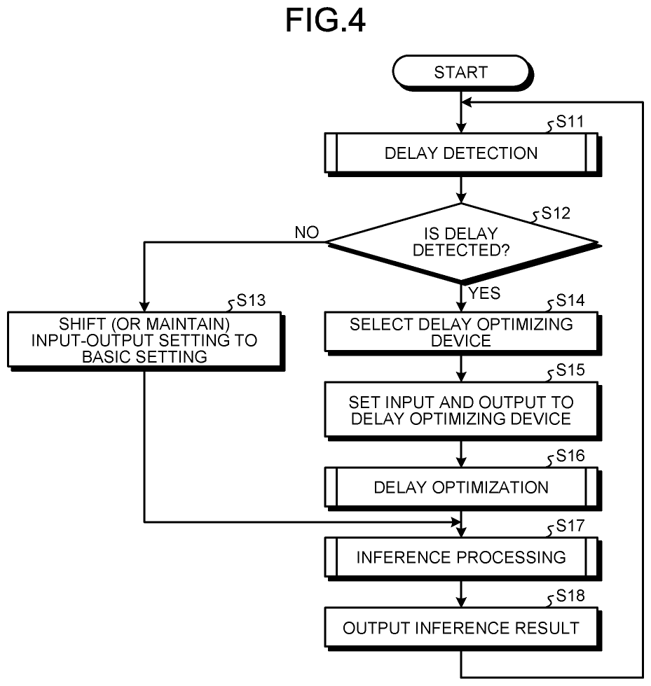

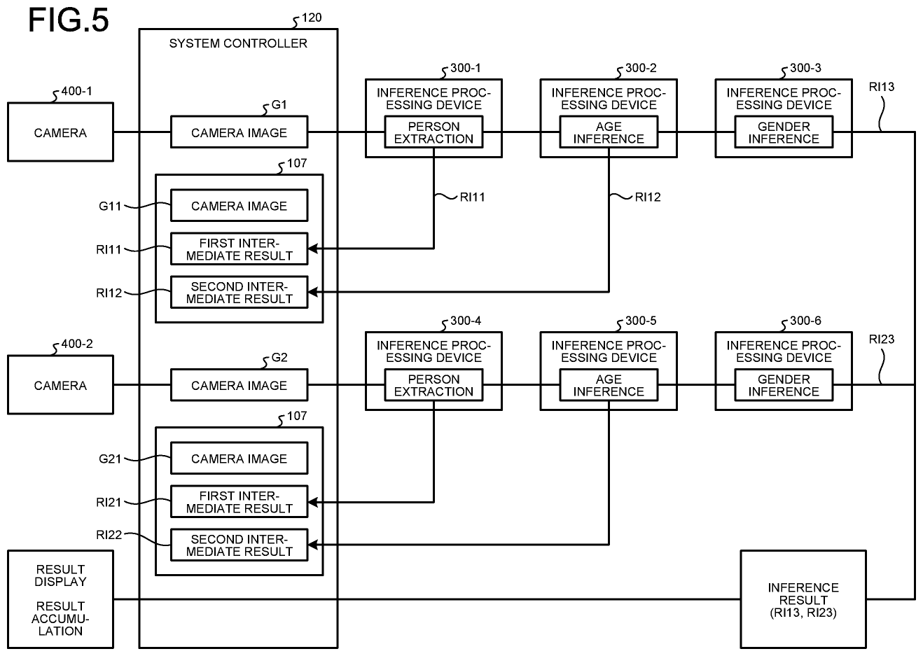

The operations of the inference processing devices 300-1 to 300-6 with no processing delay are now described with reference to FIGS. 4 and 5. FIG. 4 is a processing flowchart according to the embodiment. FIG. 5 illustrates the operations of the inference processing devices 300-1 to 300-6 with no processing delay according to a first embodiment.

The delay detector 125 of the system controller 120 performs delay detection (Step S11).

The delay handler 122 determines whether any of the inference processing devices 300-1 to 300-6 delays in the processing (Step S12).

In this case, the inference processing devices 300-1 to 300-6 have no delay in processing, so that the delay handler 122 determines no delay at Step S12 (No at Step S12).

Thus, the input-output setting is maintained at the basic setting (Step S13).

At the basic input-output setting, the inference processing device 300-1 performs the inference processing to a camera image G1 and outputs a result of the inference (i.e., person extraction inference: first intermediate result RI11) to the inference processing device 300-2.

The inference processing device 300-2 performs the inference processing to the camera image G1 and the inference result of the inference processing device 300-1 and outputs a result of the inference (i.e., age inference: second intermediate result RI12) to the inference processing device 300-3.

The inference processing device 300-3 performs the inference processing to the camera image G1 and the inference result of the inference processing device 300-2 and outputs a result of the inference (gender inference) (Step S17).

The inference result (age-inference result) of the inference processing device 300-2 and the inference result (gender-inference result) of the inference processing device 300-3 are output to the system controller 120 as a total inference result and are displayed on the display 103 or stored in the SSD 107 or the HDD 108 (Step S18).

In the same manner, the inference processing device 300-4 performs the inference processing and outputs a result of the inference (person extraction inference: first intermediate result RI11) to the inference processing device 300-5. The inference processing device 300-5 performs the inference processing and outputs a result of the inference (age inference: second intermediate result RI12) to the inference processing device 300-6. The inference processing device 300-6 performs the inference processing and outputs a result of the inference (gender inference) (Step S17).

The inference result (age-inference result) of the inference processing device 300-5 and the inference result (gender-inference result) of the inference processing device 300-6 are output to the system controller 120 as a total inference result and are displayed on the display 103 or stored in the SSD 107 or the HDD 108 (Step S18).

To detect a person from a camera image and determine the age and gender of the person, the inference processing devices 300-1 to 300-3 perform the inference processing as follows.

The inference processing device 300-1 uses the model file 304-1 to perform the person extraction inference processing for extracting a person from a camera image, as follows.

In the person extraction inference, the inference processing device 300-1 receives a camera image and a camera image identifier for identifying the camera image and extracts an image region (person region) representing a person from the camera image. The inference processing device 300-1 then outputs a first intermediate result (first inference result) RI11 including coordinate information on the person region on the camera image G1 and the person identifier for the person (person region) in association with each other together with the camera image G1 and the camera image identifier to the intermediate result acquirer 121 of the system controller 120 and the inference processing device 300-2.

As a result, the intermediate result acquirer 121 temporarily stores the first intermediate result RI11 in the SSD 107.

The inference processing device 300-2 uses the model file 304-2 to perform the age inference processing for inferring the age of the person, as follows.

In the age inference processing, the inference processing device 300-2 receives the camera image G1, the camera image identifier, and the first intermediate result RI11. The inference processing device 300-2 infers the age of the person in the person region of the camera image from the characteristics of the person region on the basis of the coordinate information on the person identifier indicated by the first intermediate result RI11. The inference processing device 300-2 then outputs the second intermediate result (second inference result) RI12 including the inferred age and the person identifier in association with each other as well as the camera image, the camera image identifier, and the first intermediate result RI11.

The inference processing device 300-3 uses the model file 304-3 to perform the gender inference processing for inferring the gender of the person.

In the gender inference processing, the inference processing device 300-3 receives the camera image, the camera image identifier, and the first intermediate result RI11. The inference processing device 300-3 infers the gender of the person in the person region of the camera image from the characteristics or of the person region on the basis of the coordinate information on the person identifier indicated by the first intermediate result RI11. The inference processing device 300-3 then outputs an intermediate result RI13 including the inferred gender and the person identifier in association with each other as well as the camera image G1, the camera image identifier, and the second intermediate result (second inference result) RI12.

The system controller 120 acquires the inference result RI13 including the camera image identifier, the first intermediate result RI11, and the second intermediate result RI12 from the inference processing device 300-3. The system controller 120 holds the inference result RI13 in association with the camera image corresponding to the camera image identifier. On the basis of a combination of the camera image and the inference result, the system controller 120 displays the ages and genders of persons inferred from the camera image or calculates the number of persons on an age and gender basis, for example.

As described above, the information processing system 1 has a pipelining configuration that the succeeding inference processing device (e.g., the inference processing device 300-2) performs the inference processing using the result of the inference processing by the preceding inference processing device (e.g., the inference processing device 300-1). Thereby, the information processing system 1 can perform multiple stages of inference processing in parallel, thereby heightening processing speed.

Meanwhile, with occurrence of processing delay in a certain stage of the multi-stage inference processing, the pipelining information processing system 1 as above may fail in the subsequent and thereafter inference processing, which retards the processing. Among the inference processing device 300-1 for the person extraction inference, the inference processing device 300-2 for the age inference, and the inference processing device 300-3 for the gender inference, if the inference processing device 300-2 delays with the age-inference processing, for example, the inference processing device 300-3 cannot perform the gender-inference processing.

In view of this, if any of the inference processing devices 300-1 to 300-3 delays in the processing, and the inference processing devices 300-4 to 300-6 have a margin of processing capacity, the information processing system 1 transfers the inference result of the inference processing device preceding the one having the processing delay to any of the inference processing devices 300-4 to 300-6. Any of the inference processing devices 300-4 to 300-6 then outputs the inference result to the inference processing device following the one having the processing delay. Thereby, the information processing system 1 can make effective use of its resources and effectively reduce the effects of the processing delay.

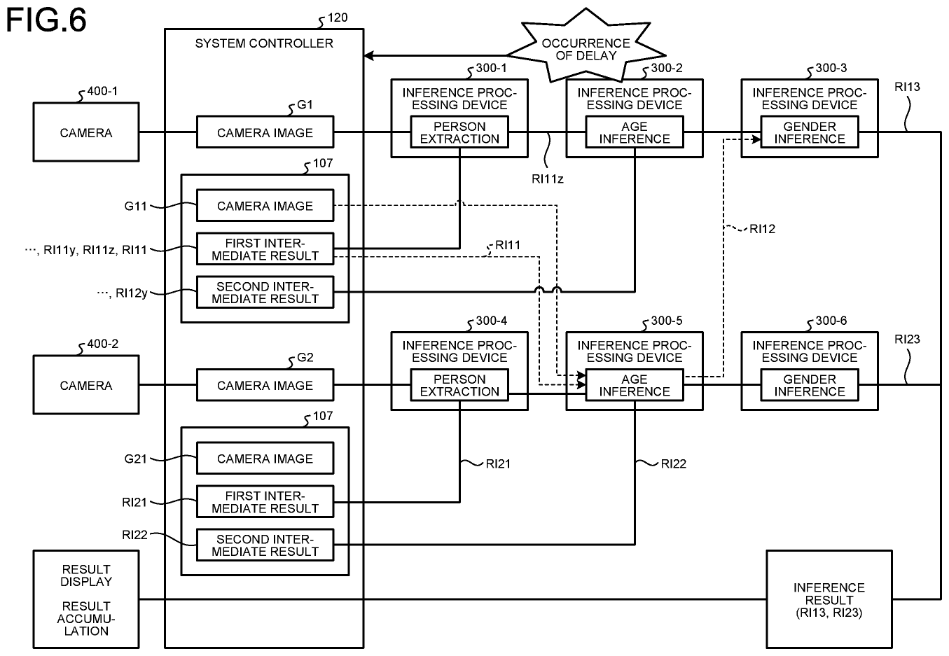

FIG. 6 illustrates the operations with processing delay according to the first embodiment.

The following describes an example that the inference processing device 300-2 delays in processing, and the inference processing device 300-5 has a relatively large margin of processing capacity, for example, with reference to FIG. 4.

The delay detector 125 of the system controller 120 performs delay detection (Step S11).

The delay handler 122 determines detection or no detection of delay from any of the inference processing devices 300-1 to 300-6 (Step S12).

In this example, the inference processing device 300-2 delays in the processing, so that the delay handler 122 determines occurrence of delay at Step S12 (Yes at Step S12).

As a result, the delay handler 122 of the system controller 120 selects the inference processing device having a largest margin of processing capacity as a delay optimizing device that can reduce the effects of the processing delay (Step S14).

Specifically, the delay handler 122 selects the inference processing device having a smallest processing load currently, that is, the inference processing device 300-5 in this example.

Subsequently, the delay handler 122 sets input and output to the delay optimizing device (Step S15).

In this case, the inference processing device 300-1 has already stored a first intermediate result RI11y, a first intermediate result RI11z, and the first intermediate result RI11 in this order from past to present in the SSD 107 of the system controller 120, as illustrated in FIG. 6. The inference processing device 300-2, however, has processing delay and is still processing the first intermediate result RI11z, so that the inference processing device 300-2 cannot start processing the first intermediate result RI11 even after predetermined processing start timing.

In this state, the delay handler 122 sets a camera image G11 and the first intermediate result RI11read from the SSD 107 as inputs to the inference processing device 300-5 being the delay optimizing device. The delay handler 122 determines the inference processing device 300-3 to be the destination of outputs from the inference processing device 300-5 being the delay optimizing device.

Consequently, the inference processing device 300-1 practically outputs the inference result (person extraction inference result: first intermediate result RI11) of the inference processing based on the camera image G1 to the inference processing device 300-5.

As a result, the inference processing device 300-5 performs the inference processing to the camera image G1 and the inference result of the inference processing device 300-1 for delay optimization and outputs the inference result (age inference result: second intermediate result RI12) to the inference processing device 300-3 (Step S16).

After receiving the second intermediate result RI12 from the inference processing device 300-5, the inference processing device 300-3 performs the inference processing to the camera image G1 and the second intermediate result RI12 being the inference result of the inference processing device 300-5 and outputs the inference result (gender inference result) (Step S17).

The inference result (age inference result) of the inference processing device 300-5 and the inference result (gender inference result) of the inference processing device 300-3 are output to the system controller 120 as a total inference result and are displayed on the display 103 or stored in the SSD 107 or the HDD 108 (Step S18).

After completing the inference processing based on the inference result (person extraction inference result: first intermediate result RI11z) of the previous inference processing to the camera image G1 by the inference processing device 300-1, the inference processing device 300-2 outputs the inference result (age inference result: second intermediate result RI12z) to the inference processing device 300-3. In the case of receiving no inference result (age inference result) RI12 from the inference processing device 300-5 or having completed the inference processing on the inference result (age inference result) RI12 of the inference processing device 300-5, the inference processing device 300-3 performs the inference processing on the inference result (age inference result) RI12z of the inference processing device 300-2. The inference result (age inference result) of the inference processing device 300-2 and the inference result (gender inference result) of the inference processing device 300-3 are output to the system controller 120 as a total inference result and are displayed on the display 103 or stored in the SSD 107 or the HDD 108 (Step S18).

As described above, the information processing system 1 transfers the inference result of the inference processing device (inference processing device 300-1 in the example above) preceding the one (inference processing device 300-2 in the example above) having processing delay to another inference processing device (inference processing device 300-5 in the example above) having a relatively large margin of processing capacity. The information processing system 1 thus causes another inference processing device to perform in parallel the inference processing to be performed by the inference processing device having the processing delay. Thereby, the information processing system 1 with a pipelining configuration can make effective use of its resources and effectively reduce the effects of the processing delay.

### Second Embodiment

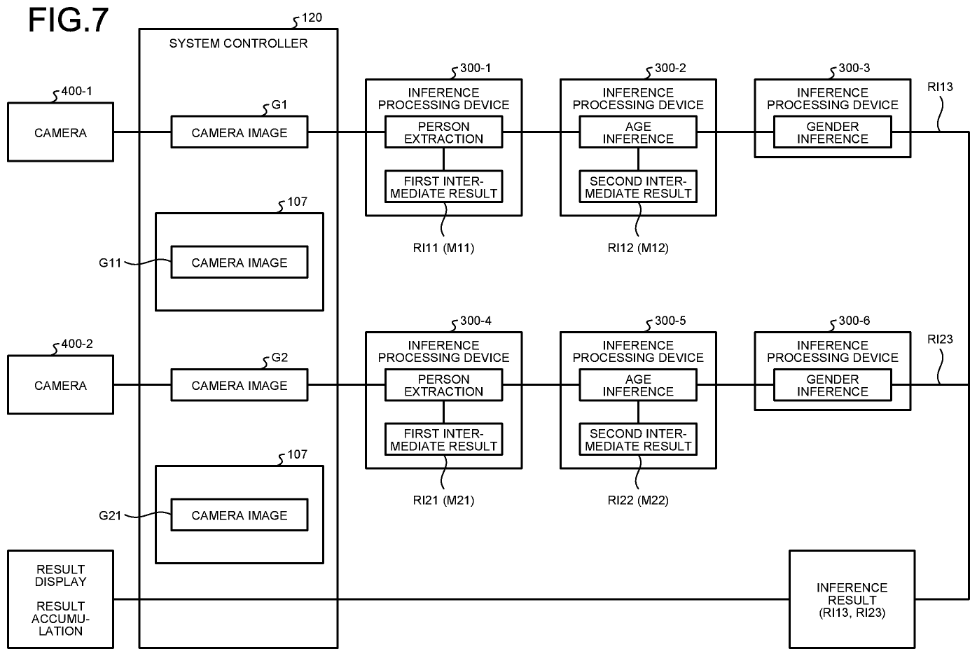

FIG. 7 illustrates the device configuration and the operations with no processing delay according to a second embodiment.

The second embodiment is different in configuration from the first embodiment in that the inference processing devices 300-1 to 300-5 according to the second embodiment include memories M11, M12, M21, and M22, respectively that store the intermediate results of the inference processing. In the first embodiment, the system controller 120 functioning as a management controller includes the SSD 107 being an inference-result storage that all the intermediate results of the inference processing performed by at least the inference processing devices (inference processing devices 300-1, 300-2, 300-4, and 300-5 in the example illustrated in FIG. 5) other than the inference processing devices in the final stage (inference processing devices 300-3 and 300-6 in the example illustrated in FIG. 5).

With no occurrence of processing delay, the operations of the second embodiment are the same as those of the first embodiment illustrated in FIG. 5 except that the inference processing devices 300-1, 300-2, 300-4, and 300-5 store intermediate results RI11, RI12, RI21, and RI22 being the results of the inference processing in the memories M11, M12, M21, and M22, respectively. For this reason, detailed explanation of the operations is omitted herein.

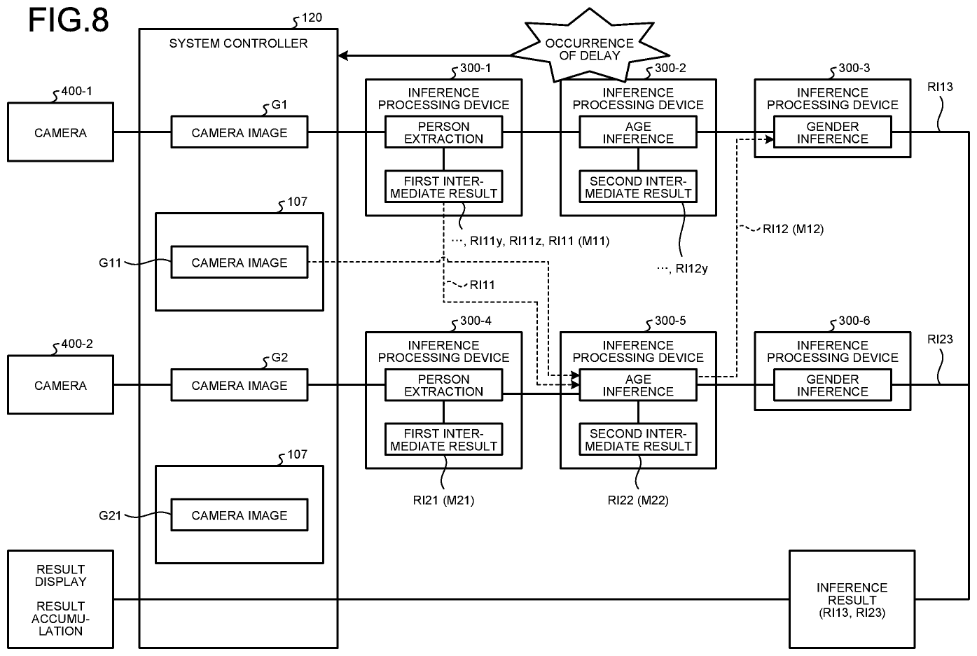

FIG. 8 illustrates the operations with processing delay according to the second embodiment.

The following describes an example that processing delay occurs in the inference processing device 300-2, and the inference processing device 300-5 has a relatively large margin of processing capacity, for example, referring back to FIG. 4.

The delay detector 125 of the system controller 120 performs delay detection (Step S11).

The delay handler 122 determines detection or no detection of delay from any of the inference processing devices 300-1 to 300-6 (Step S12).

In this example, the inference processing device 300-2 delays in the processing, so that the delay handler 122 determines occurrence of delay at Step S12 (Yes at Step S12).

As a result, the delay handler 122 of the system controller 120 selects the inference processing device having a largest margin of processing capacity as a delay optimizing device that can reduce the effects of the processing delay (Step S14).

Specifically, the delay handler 122 selects the inference processing device having a smallest processing load currently, that is, the inference processing device 300-5 in this example.

Subsequently, the delay handler 122 sets input and output to the delay optimizing device (Step S15).

In this case, the inference processing device 300-1 has already stored the first intermediate result RI11y, the first intermediate result RI11z, and the first intermediate result RI11 in this order from past to present in the memory M11 as illustrated in FIG. 8. The inference processing device 300-2, however, has processing delay and is still processing the first intermediate result RI11z. That is, the inference processing device 300-2 cannot start processing the first intermediate result RI11 even after predetermined processing start timing.

In this state, the delay handler 122 determines the camera image G11 read from the SSD 107 of the system controller 120 and the first intermediate result RI11 read from the memory M11 as inputs to the inference processing device 300-5 being the delay optimizing device. The delay handler 122 determines the inference processing device 300-3 to be the destination of outputs from the inference processing device 300-5 being the delay optimizing device.

Consequently, the inference processing device 300-1 practically outputs the inference result (person extraction inference result: first intermediate result RI11) of the inference processing to the camera image G1 to the inference processing device 300-5.

As a result, the inference processing device 300-5 performs the inference processing to the camera image G1 and the inference result RI11 of the inference processing device 300-1 for delay optimization and outputs the inference result (age inference result: second intermediate result RI12) to the inference processing device 300-3 (Step S16).

In the case of receiving the second intermediate result RI12 from the inference processing device 300-5, the inference processing device 300-3 performs the inference processing to the camera image G1 and the second intermediate result RI12 being the inference result of the inference processing device 300-5 and outputs the inference result (gender inference result) (Step S17).

The inference result (age inference result) of the inference processing device 300-5 and the inference result (gender inference result) of the inference processing device 300-3 are output to the system controller 120 as a total inference result and are displayed on the display 103 or stored in the SSD 107 or the HDD 108 (Step S18).

After completing the inference processing based on the previous inference result (person extraction inference result: first intermediate result RI11z) of the inference processing to the camera image G1 by the inference processing device 300-1, the inference processing device 300-2 outputs the inference result (age inference result: second intermediate result RI12z) to the inference processing device 300-3. In the case of receiving no inference result (age inference result) RI12 from the inference processing device 300-5 or having completed the inference processing on the inference result (age inference result) RI12 of the inference processing device 300-5, the inference processing device 300-3 performs the inference processing on the inference result (age inference result) RI12z of the inference processing device 300-2. The inference result (age inference result) of the inference processing device 300-2 and the inference result (gender inference result) of the inference processing device 300-3 are output to the system controller 120 as a total inference result and are displayed on the display 103 or stored in the SSD 107 or the HDD 108 (Step S18).

As described above, the information processing system 1 according to the second embodiment transfers the inference result of the inference processing device (inference processing device 300-1 in the example above) preceding the one (inference processing device 300-2 in the example above) having processing delay to another inference processing device (inference processing device 300-5 in the example above) having a relatively large margin of processing capacity. The information processing system 1 thus causes another inference processing device to perform in parallel the inference processing to be performed by the inference processing device having the processing delay. Consequently, the information processing system 1 with a pipelining configuration can make effective use of its resources and effectively reduce the effects of the processing delay.

### Third Embodiment

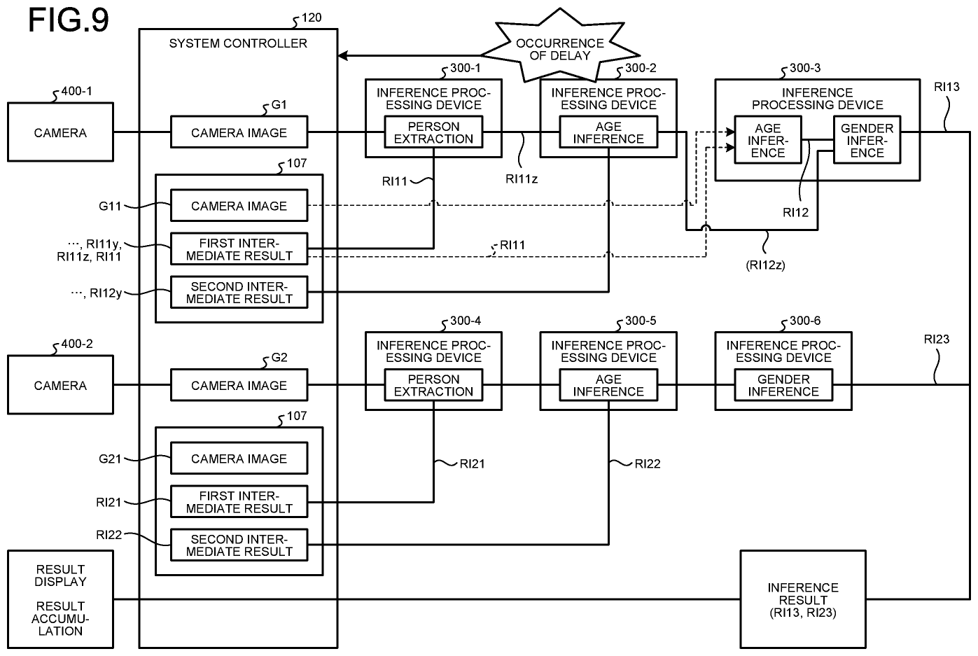

FIG. 9 illustrates the device configuration and the operations with processing delay according to a third embodiment.

The third embodiment is different in configuration from the first and second embodiments in that the processing of the inference processing device having processing delay is selectively allocated to the one assigned with inference processing other than the same inference processing as that of the inference processing device having the processing delay detected, and the one to which the same inference processing is additionally allocable. The first and the second embodiments allocate one inference operation to each of the inference processing devices 300-1 to 300-6.

With occurrence of no processing delay, the third embodiment performs the same operations as the first embodiment illustrated in FIG. 5. For this reason, detailed explanation of the operations is omitted herein.

FIG. 9 illustrates the operations with no processing delay according to the third embodiment.

The following describes an example that processing delay occurs in the inference processing device 300-2, and the inference processing device 300-3 has a relatively large margin of processing capacity and the processing of the inference processing device 300-2 is additionally allocable to the inference processing device 300-3, for example, with reference to FIG. 4.

The delay detector 125 of the system controller 120 performs delay detection (Step S11).

The delay handler 122 determines detection or no detection of delay from any of the inference processing devices 300-1 to 300-6 (Step S12).

In this case, processing delay occurs in the inference processing device 300-2, so that the delay handler 122 determines occurrence of delay at Step S12 (Yes at Step S12).

As a result, the delay handler 122 of the system controller 120 selects the inference processing device having a largest margin of processing capacity as a delay optimizing device that can reduce the effects of the processing delay (Step S14).

Specifically, the delay handler 122 selects the inference processing device having a relatively large margin of processing capacity and to which the processing of the inference processing device 300-2 is additionally allocable, that is, the inference processing device 300-3 in this example.

Subsequently, the inference processing controller 123 of the system controller 120 additionally allocates the model file 304-2 (or one similar enough to obtain the same processing result) of the inference processing device 300-2 to the inference processing device 300-3 to place the device 300-3 in an operable state. The delay handler 122 sets input and output to the delay optimizing device (Step S15).

Also in this case, the inference processing device 300-1 has already stored the first intermediate result RI11y, the first intermediate result RI11z, and the first intermediate result RI11 in this order from past to present in the SSD 107 as illustrated in FIG. 9. The inference processing device 300-2, however, has processing delay and is still processing the first intermediate result RI11z. As a result, the inference processing device 300-2 cannot start processing the first intermediate result RI11 even after predetermined processing start timing.

In this state, the delay handler 122 determines the camera image G11 and the first intermediate result RI11 read from the SSD 107 of the system controller 120 as inputs to the inference processing device 300-3 being the delay optimizing device. The delay handler 122 determines the input of the model file 304-3 that outputs the gender inference result of the inference processing device 300-3 to be the destination of outputs from the inference application 303 using the model file 304-2 of the inference processing device 300-3 being the delay optimizing device that outputs the age inference result.

Consequently, the inference processing device 300-1 practically outputs the inference result (person extraction inference result: first intermediate result RI11) of the inference processing to the camera image G1 to the inference processing device 300-3. The inference processing device 300-3 practically performs the inference processing of the inference processing device 300-2 and its own inference processing in series.

As a result, the inference processing device 300-3 performs the age inference processing to the camera image G1 and the inference result RI11 of the inference processing device 300-1 for delay optimization (Step S16). The inference processing device 300-3 also performs the gender inference processing to the inference result (age inference result: second intermediate result RI12) and outputs the inference result (gender inference result) (Step S17).

The inference results (age inference result and gender inference result) of the inference processing device 300-3 are output to the system controller 120 as a total inference result and are displayed on the display 103 or stored in the SSD 107 or the HDD 108 (Step S18).

After completing the inference processing based on the previous inference result (person extraction inference result: first intermediate result RI11z) of the inference processing to the camera image G1 by the inference processing device 300-1, the inference processing device 300-2 outputs the inference result (age inference result: second intermediate result RI12z) to the inference processing device 300-3. After completing the inference processing (age inference and gender inference) to the inference result RI11 of the inference processing device 300-1, the inference processing device 300-3 performs the inference processing on the inference result (age inference result) RI12z of the inference processing device 300-2. The inference result (age inference result) of the inference processing device 300-2 and the inference result (gender inference result) of the inference processing device 300-3 are output to the system controller 120 as a total inference result and are displayed on the display 103 or stored in the SSD 107 or the HDD 108 (Step S18).

As described above, the information processing system 1 according to the third embodiment transfers the inference result of the inference processing device (inference processing device 300-1 in the example above) preceding the inference processing device (inference processing device 300-2 in the example above) having processing delay to another inference processing device (inference processing device 300-3 in the example above) having a relatively large margin of processing capacity. The information processing system 1 thus causes the inference processing device 300-3 to perform in parallel two inference operations including the inference operation to be performed by the inference processing device having the processing delay. Consequently, the information processing system 1 with a pipelining configuration can make effective use of its resources and effectively reduce the effects of the processing delay.

### Fourth Embodiment

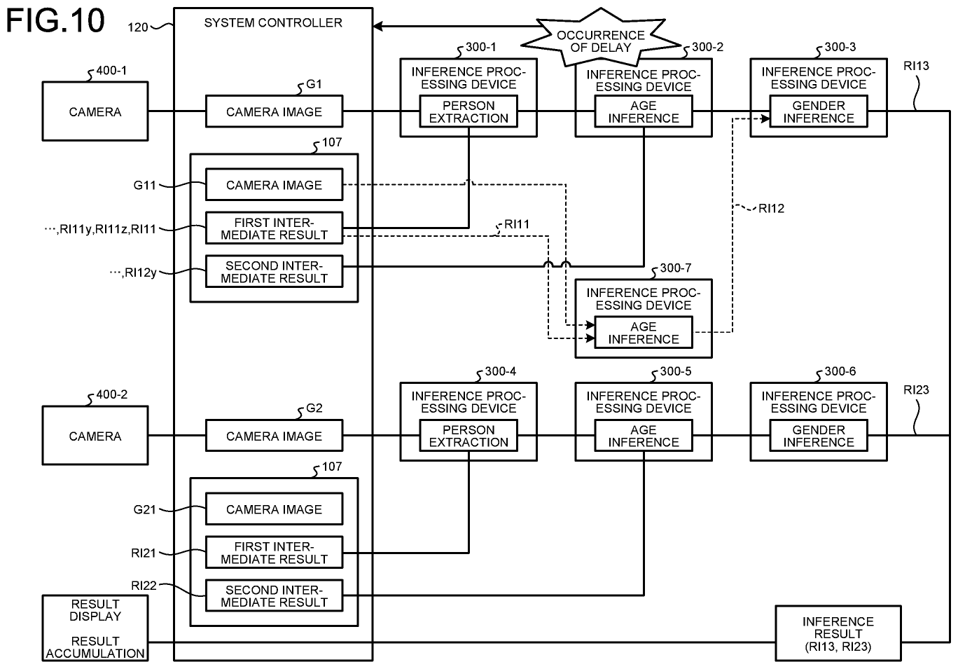

FIG. 10 illustrates the device configuration and the operations with no processing delay according to a fourth embodiment.

The fourth embodiment is different in configuration from the first embodiment in allocating the processing of the inference processing device having processing delay to a spare inference processing device to which no inference processing is allocated at the time of detection of the processing delay.

With no occurrence of processing delay, the fourth embodiment performs the same operations as those of the first embodiment illustrated in FIG. 5. For this reason, detailed explanation of the operations is omitted herein.

The following describes an example that processing delay occurs in the inference processing device 300-2, and the information processing system 1 includes a spare inference processing device 300-7 to which no inference processing is allocated, with reference to FIG. 4.

The delay detector 125 of the system controller 120 performs delay detection (Step S11).

The delay handler 122 determines detection or no detection of delay from any of the inference processing devices 300-1 to 300-6 (Step S12).

In this example, the inference processing device 300-2 delays in the processing, so that the delay handler 122 determines occurrence of delay at Step S12 (Yes at Step S12).

As a result, the delay handler 122 of the system controller 120 selects a spare inference processing device to having allocated no inference processing at the time of detection of the processing delay (Step S14).

Specifically, the delay handler 122 selects a spare inference processing device having allocated no inference processing currently, that is, the inference processing device 300-7 in this example.

Subsequently, the inference processing controller 123 of the system controller 120 allocates the model file 304-2 allocated to the inference processing device 300-2 (or one similar enough to obtain the same processing result) to the inference processing device 300-7 to place the inference processing device 300-7 in an operable state. The delay handler 122 sets input and output to the delay optimizing device (Step S15).

In this case, the inference processing device 300-1 has already stored the first intermediate result RI11y, the first intermediate result RI11z, and the first intermediate result RI11 in this order from past to present in the SSD 107 as illustrated in FIG. 10. The inference processing device 300-2, however, has processing delay and is still processing the first intermediate result RI11z. As a result, the inference processing device 300-2 cannot start processing the first intermediate result RI11 even after predetermined processing start timing.

In this state, the delay handler 122 determines the camera image G11 and the first intermediate result RI11 read from the SSD 107 of the system controller 120 as inputs to the inference processing device 300-7 being the delay optimizing device. The delay handler 122 determines the inference processing device 300-3 to be the destination of outputs from the inference processing device 300-7 being the delay optimizing device.

Consequently, the inference processing device 300-1 practically outputs the inference result (person extraction inference result: first intermediate result RI11) of the inference processing to the camera image G1 to the inference processing device 300-7. The inference processing device 300-3 practically receives the inference result of the inference processing device 300-7.

As a result, the inference processing device 300-7 performs the inference processing to the camera image G1 and the inference result RI11l of the inference processing device 300-1 for delay optimization and outputs the inference result (age inference result: second intermediate result RI12) to the inference processing device 300-3 (Step S16).

After receiving the second intermediate result R112 from the inference processing device 300-7, the inference processing device 300-3 performs the inference processing to the camera image G1 and the second intermediate result R112 being the inference result of the inference processing device 300-7 and outputs the inference result (gender inference result) (Step S17).

The inference result (age inference result) of the inference processing device 300-7 and the inference result (gender inference result) of the inference processing device 300-3 are output to the system controller 120 as a total inference result and are displayed on the display 103 or stored in the SSD 107 or the HDD 108 (Step S18).

After completing the inference processing to the previous inference result (person extraction inference result: first intermediate result RI11z) of the inference processing to the camera image G1 by the inference processing device 300-1, the inference processing device 300-2 outputs the inference result (age inference result: second intermediate result RI12z) to the inference processing device 300-3. When receiving no inference result (age inference result) RI11 from the inference processing device 300-7 or having completed the inference processing to the inference result (age inference result) RI11 of the inference processing device 300-7, the inference processing device 300-3 performs the inference processing to the inference result (age inference result) RI12z of the inference processing device 300-2. The inference result (age inference result) of the inference processing device 300-2 and the inference result (gender inference result) of the inference processing device 300-3 are output to the system controller 120 as a total inference result and are displayed on the display 103 or stored in the SSD 107 or the HDD 108 (Step S18).

As described above, the information processing system 1 according to the fourth embodiment transfers the inference result of the inference processing device (inference processing device 300-1 in the example above) preceding the inference processing device (inference processing device 300-2 in the example above) having processing delay to another processing device (inference processing device 300-7 in the example above) to which no inference processing is allocated. The information processing system 1 thus causes another inference processing device to perform in parallel the inference processing to be performed by the inference processing device having the processing delay. Consequently, the information processing system 1 with a pipelining configuration can make effective use of its resources and practically reduce the effects of the processing delay.

Modifications

This disclosure is not limited to the first to fourth embodiments and may be embodied in a variety of other forms without departing from the spirit of the embodiments. The elements and the processing according to the embodiments may be selected as necessary or appropriately combined.

The above embodiments has described the PCIe as an example of the I/O interface of the relative elements, however, the I/O interface is not limited to PCIe. The I/O interface for the elements may be optionally set as long as it allows data transfer between a device (peripheral controller) and a processor via a data transfer bus, for example. The data transfer bus may be a general-purpose bus through which data can be transferred at high speed in a local environment (e.g., one system or one device) of one housing, for example. The I/O interface may be either a parallel interface or a serial interface.

The I/O interface for serial transfer may be point-to-point connectable and allow data transfer on a packet basis. In serial transfer, the I/O interface may include a plurality of lanes. The layer structure of the I/O interface may include a transaction layer for packet generation and decoding, a data link layer for error detection, and a physical layer for serial and parallel conversion. The I/O interface may include a root complex at the topmost hierarchy and including one or more ports, an end point serving as an I/O device, a switch for increasing the number of ports, and a bridge that converts protocols, for example. The I/O interface may multiplex data and clock signals with a multiplexer for transmission. In this case, the receive side may divide the data and the clock signals with a demultiplexer.

The disclosure described above enables skilled person to implement and produce the embodiments.

Additional Aspects

The following describes additional aspects of the first to fourth embodiments.

### First Aspect

An inference processing system according to a first aspect of the embodiments includes inference processing devices and performs inference processing such that a succeeding inference processing device performs inference processing to a result of inference processing performed by a preceding inference processing device. The inference processing system includes inference-result storage that stores therein results of the inference processing of the inference processing devices; a processing delay detector configured to detect occurrence of delay in the inference processing of the inference processing devices; a selector configured to select one of the inference processing devices, the one being executable of inference processing same as the inference processing of the inference processing device having the delay; and an input-output controller configured to input, to the inference processing device selected by the selector, the result of the inference processing of the inference processing device preceding the inference processing device having the delay, and to cause the selected inference processing device to output the result of the inference processing to the inference processing device succeeding the inference processing device having the delay.

With this configuration, the inference processing system transfers the inference result of the inference processing device preceding the inference processing device having the processing delay to the selected inference processing device. The inference processing system causes the selected inference processing device to perform the inference processing of the inference processing device having the processing delay and output the inference result to the inference processing device succeeding the inference processing device having the processing delay. Consequently, the inference processing system can make effective use of its resources and effectively reduce the effects of the processing delay.

### Second Aspect

According to a second aspect of the embodiments, the inference processing system includes a management controller that controls the inference processing devices. The management controller includes the inference-result storage. The inference-result storage stores therein the results of the inference processing of the inference processing devices other than at least the inference processing device in a final stage.

With this configuration, the management controller manages the inference results of the inference processing devices, thereby efficiently dealing with occurrence of processing delay, considering the entire inference processing system.

### Third Aspect

According to a third aspect of the embodiments, the inference processing devices each include the inference-result storage that stores therein the inference result of the corresponding inference processing device.

With this configuration, the inference results are stored in the respective inference processing devices. Consequently, the inference processing system can make effective use of its resources and effectively reduce the effects of the processing delay, if it occurs, in a simpler manner while distributing processing load.

### Fourth Aspect

According to a fourth aspect of the embodiments, the selector of the inference processing system selects a spare inference processing device to which no inference processing is allocated at the time of detection of the delay.

With this configuration, the inference processing system can deal with the processing delay, if it occurs, in a simpler manner without affecting other processing, thereby reducing the effects of the processing delay.

### Fifth Aspect

According to a fifth aspect of the embodiments, the selector of the inference processing system selects an inference processing device to which the same inference processing as the inference processing of the inference processing device having the delay detected is additionally allocable.

With this configuration, the inference processing system additionally allocates the inference processing to the selected inference processing device having a relatively large margin of processing capacity in response to occurrence of processing delay. Consequently, the inference processing system can make effective use of its resources and effectively reduce the effects of the processing delay.

### Sixth Aspect

According to a sixth aspect of the embodiments, the selector selects an inference processing device having allocated the same inference processing as the inference processing of the inference processing device having the delay detected and estimated to have no delay.

With this configuration, the inference processing system can simply determine the selected second inference processing device to be the input destination and determine the inference processing device following the inference processing device having the processing delay to be the output destination of the selected inference processing device. Consequently, the inference processing system can reduce the effects of the processing delay in a simpler manner.

### Seventh Aspect

According to a seventh aspect of the embodiments, the inference processing system performs a series of inference processing to an input image. The inference-result storage stores therein the image subjected to the series of inference processing, and adds information for identifying the image to the results of the inference processing of the inference processing devices for storage.

Consequently, the inference processing system can cause the selected inference processing device to perform the inference processing to be performed by the inference processing device having the processing delay simply by changing data input and output destinations.

### Eighth Aspect

An inference processing device according to an eighth aspect of the embodiments is for use in an inference processing system that includes inference processing devices to perform pipelining inference processing. The inference processing device includes an inference processor configured to perform inference processing to input data; and inference-result storage that stores therein a result of the inference processing by the inference processor.

With this configuration, each of the inference processing devices can store the inference results. Thereby, the inference processing system can make effective use of its resources and effectively reduce the effects of processing delay, if it occurs, in a simpler manner while distributing processing load.

### Ninth Aspect

A computer program product according to a ninth aspect of the embodiments includes programmed instructions embodied in and stored on a non-transitory computer readable medium The computer program product is for controlling, by a computer, a pipelining inference processing system including inference processing devices. The inference processing system performs inference processing such that a succeeding inference processing device performs inference processing to a result of inference processing performed by a preceding inference processing device. The instructions, when executed by the computer, cause the computer to perform: storing results of the inference processing of the inference processing devices; detecting occurrence of delay in the inference processing of the inference processing devices; selecting one of the inference processing device, the one being executable of inference processing same as the inference processing of the inference processing device having the delay; and inputting, to the selected inference processing device, the result of the inference processing of the inference processing device preceding the inference processing device having the delay, and causing the selected inference processing device to output the result of the inference processing to the inference processing device succeeding the inference processing device having the delay.

With this configuration, the inference processing system transfers the inference result of the inference processing device preceding the inference processing device having the processing delay to the selected inference processing device. The inference processing system causes the selected inference processing device to perform the inference processing of the inference processing device having the processing delay and output the inference result to the inference processing device succeeding the inference processing device having the processing delay. Consequently, the inference processing system can make effective use of its resources and effectively reduce the effects of the processing delay.

According to one aspect, the inference processing system can appropriately distribute processing load through the inference processing and efficiently perform the inference processing.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An inference processing system comprising inference processing devices, the inference processing system that performs inference processing such that a succeeding inference processing device performs inference processing to a result of inference processing performed by a preceding inference processing device, the inference processing system comprising:
inference-result storage that stores therein results of the inference processing of the inference processing devices;
a processing delay detector that detects occurrence of delay in the inference processing of the inference processing devices;
a selector that selects one of the inference processing devices, the one being executable of inference processing same as the inference processing of the inference processing device having the delay; and
an input-output controller that:
inputs, to the inference processing device selected by the selector, the result of the inference processing of the inference processing device preceding the inference processing device having the delay, and
causes the selected inference processing device to output the result of the inference processing to the inference processing device succeeding the inference processing device having the delay.

2. The inference processing system according to claim 1, further comprising:
a management controller that controls the inference processing devices, wherein
the management controller comprises the inference-result storage, and
the inference-result storage stores therein the results of the inference processing of the inference processing devices other than at least the inference processing device in a final stage.

3. The inference processing system according to claim 1, wherein
the inference processing devices each comprise the inference-result storage that stores therein the inference result of the corresponding inference processing device.

4. The inference processing system according to claim 1, wherein
the selector selects a spare inference processing device to which no inference processing is allocated at the time of detection of the delay.

5. The inference processing system according to claim 1, wherein
the selector selects an inference processing device to which the same inference processing as the inference processing of the inference processing device having the delay detected is additionally allocable.

6. The inference processing system according to claim 1, wherein
the selector selects an inference processing device having allocated the same inference processing as the inference processing of the inference processing device having the delay detected and estimated to have no delay.

7. The inference processing system according to claim 1, wherein
the inference processing system performs a series of inference processing to an input image, and
the inference-result storage stores therein the image subjected to the series of inference processing, and adds information for identifying the image to the results of the inference processing of the inference processing devices for storage.

8. An inference processing device for use in an inference processing system that comprises inference processing devices to perform pipelining inference processing, the inference processing device comprising:
an inference processor that performs inference processing to input data; and
inference-result storage that stores therein a result of the inference processing by the inference processor.

9. A non-transitory computer readable medium comprising a computer program including programmed instructions embodied in for controlling, by a computer, a pipelining inference processing system comprising inference processing devices, the inference processing system that performs inference processing such that a succeeding inference processing device performs inference processing to a result of inference processing performed by a preceding inference processing device, wherein the instructions, when executed by the computer, cause the computer to:
store results of the inference processing of the inference processing devices;
detect occurrence of delay in the inference processing of the inference processing devices;
select one of the inference processing device, the one being executable of inference processing same as the inference processing of the inference processing device having the delay; and
input, to the selected inference processing device, the result of the inference processing of the inference processing device preceding the inference processing device having the delay, and
cause the selected inference processing device to output the result of the inference processing to the inference processing device succeeding the inference processing device having the delay.
